(19) United States
(12) Patent Application Publication
(10) Pub. No.: US 2004/0081128 A1
(43) Pub. Date: Apr. 29, 2004

(54) Method for relocating the diversity point of a mobile station in a radio access network

(76) Inventors: Bruno Fiter, Lannion (FR); Hans-Ulrich Flender, Ulm (DE); Notker Gerlich, Haar (DE); Chris Larmour, Munchen (DE); Thomas Reim, Balzheim (DE); Eddy Troch, Lint (BE)

Correspondence Address: STAAS & HALSEY LLP, SUITE 700, 1201 NEW YORK AVENUE, N.W., WASHINGTON, DC, 20005, US

(21) Appl. No.: 10/469,147

(22) PCT Filed: Feb. 8, 2002
(86) PCT No.: PCT/EP02/01340

(30) Foreign Application Priority Data
Feb. 27, 2001 (EP) 01104811.3
Feb. 27, 2001 (DE) 101 09 332.2

(51) Int. Cl. H04Q 7/24

(52) U.S. Cl. 370/338

(57) ABSTRACT

A mobile station communicates in a communication network formed of a core network and a radio access network with at least one first and one second radio network control device. The management of the mobile station or the transmission of data to be transmitted to the mobile station is handed over from the first radio network control device to the second radio network control device. To facilitate relocation, data that arrive after handover at the first radio network control device or that are temporarily stored there are transmitted to corresponding functionality of the second radio network control device using a functionality of the first radio network control device and are forwarded from the second radio network control device to the mobile station.

The invention relates to a method for relocating a diversity point of a mobile station with features according to the preamble of Claim 1 and a radio communication system with features according to the preamble of Claim 13.

Mobile radio communication systems can be divided up into a core network CN, in which the useful and signaling data of a number of terminals is carried over long distances using lines and a radio access network RAN, which generally comprises a number of physical network nodes, in particular radio network controllers, the task of which is to convert data received from the terminals into a suitable format for transmission on the core network CN and conversely to adapt the format of data received from the core network for radio transmission and forward it to the radio station, in the transmission range of which the terminal in question is located.

Highly developed communication systems, such as GSM (Global Systems for Mobile Communications) or UMTS (Universal Mobile Telecommunication Systems) mobile radio systems and data networks, which are subject to control by a packet transmission protocol, particularly the internet protocol IP, allow a number of mobile stations to set up a radio connection in parallel via a network controller of the corresponding communication network and use it to exchange data with remote devices. In order to prevent disruptive superimposition of the signals of the many radio connections, each instance of communication between the individual mobile stations and the respectively assigned network controller takes place for example via uniquely assigned frequencies, within permanently assigned time slots and/or using coded signals.

The data to be forwarded comprises on the one hand useful data, i.e. data which is to be transmitted between two mobile station users, and on the other hand signaling data, which is generated and processed to control internal processes of the mobile radio communication system. Both types of data have to be exchanged between the radio access network and a mobile station communicating with said radio access network.

In the radio access network a distinction can be made between functionalities which are responsible for the transmission of useful data and functionalities which are responsible for carrying signaling data. The former are referred to as user plane functions UPF and the latter as control plane functions CPF.

The present invention is described below using a UMTS-based mobile radio system. The characteristics of the system according to the invention can however equally be transferred to GSM-based mobile radio systems.

Each radio network controller has a number of user plane functions, each of which is assigned an address within the access network, by means of which data packets intended for a specific mobile station are forwarded to the UPF, which communicates with said mobile station.

The exchange of signaling protocols in the radio access network is controlled by user equipment functions UEF, which can be housed in a radio control server RCS, which forms a further physical node in the radio access network RAN.

When a mobile station moves completely out of the area of coverage of a base station of a radio network controller, said base station or the corresponding diversity leg must be removed from what is known as the diversity tree, while conversely base stations or diversity legs have to be added without a break in transmission, when the mobile station moves into their area of coverage. Such a transfer mechanism, with which the mobile station constantly communicates with a number of base stations, is referred to as a “soft handover”.

Contrary to this, what is known as a “hard handover” breaks the connection to a base station abruptly and has to be transferred immediately to another base station.

The present invention allows the relocation of a mobile station with both a soft and with a hard handover.

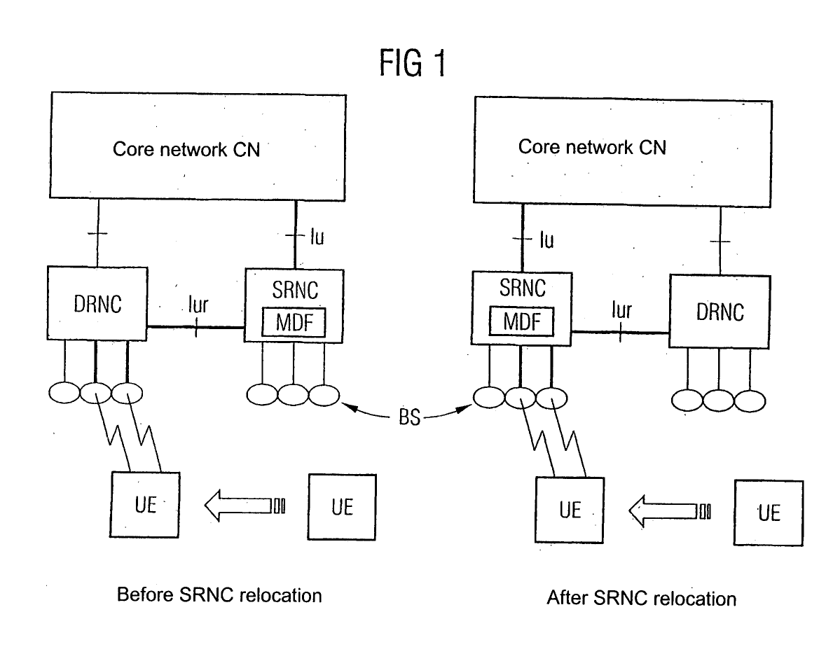

A known solution for handing over or relocating the diversity point in a radio access network is described below. FIG. 1 shows two situations in such a network. Each shows a core network CN, which is connected to a serving radio network controller SRNC and a drift radio network controller (DRNC). A number of radio stations or base stations BS is connected to both radio network controllers DRNC and SRNC. The left-hand diagram shows a situation in which a mobile station UE moves out of the area of the serving radio network controller SRNC into the area of a drift radio network controller DRNC and in doing so is still fully assigned to the serving radio network controller.

After the radio contact shown with two base stations BS each of the drift radio network controller DRNC, a data exchange takes place between the mobile station UE and the core network CN via the radio connections, via the connections between the corresponding base stations BS and the drift radio network controller DRNC, via a connection Iur with the serving radio network controller SRNC and via a connection Iu with the core network CN or vice versa.

Once the conditions for handover or relocation are present, the previously targeted drift radio network controller DRNC takes over the function of the serving radio network controller SRNC, as shown in the right-hand diagram. Data communication between the mobile station UE and the core network CN now takes place directly from the mobile station UE via one of the corresponding base stations BS, via the serving radio network controller SRNC and via a connection Iu or vice versa.

For UMTS, version 99, in the 3^{rd} Generation Partnership Project 3GPP, a relocation function was standardized for relocation with the term “Serving RNC Relocation”. This solution allows the exclusive application of UMTS-specific protocols (3GPP TS 23.060). The relocation procedure used to date is however relatively complicated and time-consuming.

It is therefore the object of the present invention to reduce data packet loss during the relocation of a mobile station.

This object is achieved by the method for relocating with the features of Claim 1 and by a communication system for implementing such a method according to the features of Claim 13.

Advantageous embodiments are set out in the dependent claims.

A method for relocating a mobile station with a low level of data packet loss in a radio communication network with at least one first and one second radio network controller, with the management of the mobile station and/or the transmission of data to be transmitted to the mobile station being handed over from the first radio network controller to the second radio network controller is particularly advantageous, if data which arrives at the first radio network controller after handover or is stored there temporarily, is transmitted using a functionality of the first radio network controller to a corresponding functionality of the second radio network controller and forwarded from there to the mobile station.

Relocation of the mobile station, i.e. the setting up of the new transmission route between the core network and the mobile station, is carried out according to a development of the invention using a mobile internet protocol MIP. The current MIP standard is either IETF MIPv4 (RFC2002) or IETF MIPv6 (draft_IETF_mobileIP_Ipv6_{—}12).

A mobile anchor function MAF is particularly suitable as a functionality which is used to transmit data between the two radio network controllers. A MAF is used particularly with large radio access networks in which too much time is required to reach the home agent. A MAF is therefore provided as a new entity in the radio network controllers. See also IETF draft HMIPv4v6: draft_elmalki_soliman_HMIPv4v6_{—}00 with regard to this.

A virtual mobile host is preferably generated as the client for carrying out MIP registration of the mobile station.

If the mobile station itself does not have a virtual mobile host, such a host can for example be created in the radio network controller, which operates as a (new) serving radio network controller.

Setting up a virtual mobile host in the serving radio network controller in relation to handover, allows deployment in existing systems without expensive structural or program changes.

The virtual host takes over the function assigned to the mobile station according to the MIP standard in respect of re-registration and address management and also preferably takes over the function of an address storage unit and address manager for network-internal addresses of importance to the function.

When the virtual mobile host has been set up, it preferably registers with the home agent, the new local mobile anchor function and in the core network. In the case of the solution in which the VMH is a component of the mobile station, the planned IETF standard HMIP for the client function should be extended to include a registration process with the serving mobile anchor function.

According to a preferred development of the invention the virtual mobile host is set up by a radio control server RCS and in particular by a user equipment function UEF, which is a component of the RCS.

In order to forward data which arrives at the first radio network controller after handover or is stored there temporarily, to the second radio network controller, the virtual mobile host transmits the address of the local MAF to the MAF of the first radio network controller.

The handover, i.e. the transfer of management to the second radio network controller, is preferably initiated by the mobile station.

According to a further preferred development of the invention, data which arrives during the handover of management to a radio network controller is stored temporarily.

After management has been handed over, the resources of the mobile station are deleted in the first radio network controller, in particular the user plane function UPF.

The mobile station is preferably relocated using the mobile internet protocol MIPv6.

Advantageously a radio communication system with at least one first and one second radio network controller to manage at least one mobile station, with the option of management of the mobile station and/or the transmission of data to be transmitted to the mobile station being handed over from the first radio network controller to the second radio network controller, allows the deployment of such a method, if at least one device is provided for carrying out IP registration, such as for example a virtual mobile host.

The invention is described in more detail below using the attached drawings. These show:

FIG. 1 the situation in a radio network before and after relocation of a mobile station according to the UMTS standard, version 99;

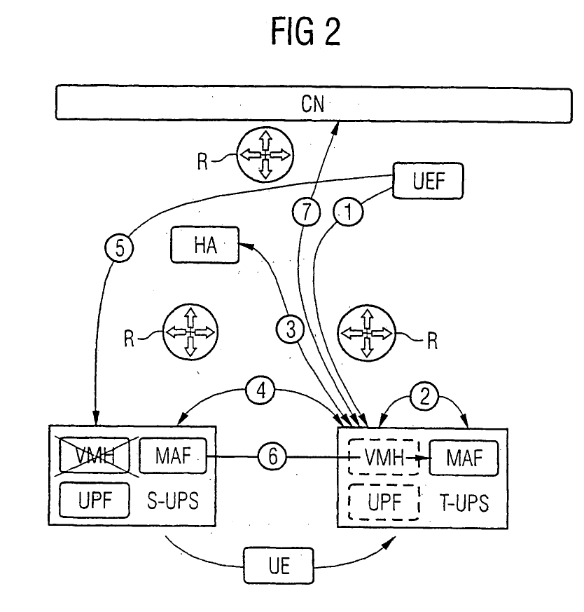

FIG. 2 a schematic flow diagram of a relocation procedure according to an embodiment of the invention in an IP-based radio access network; and

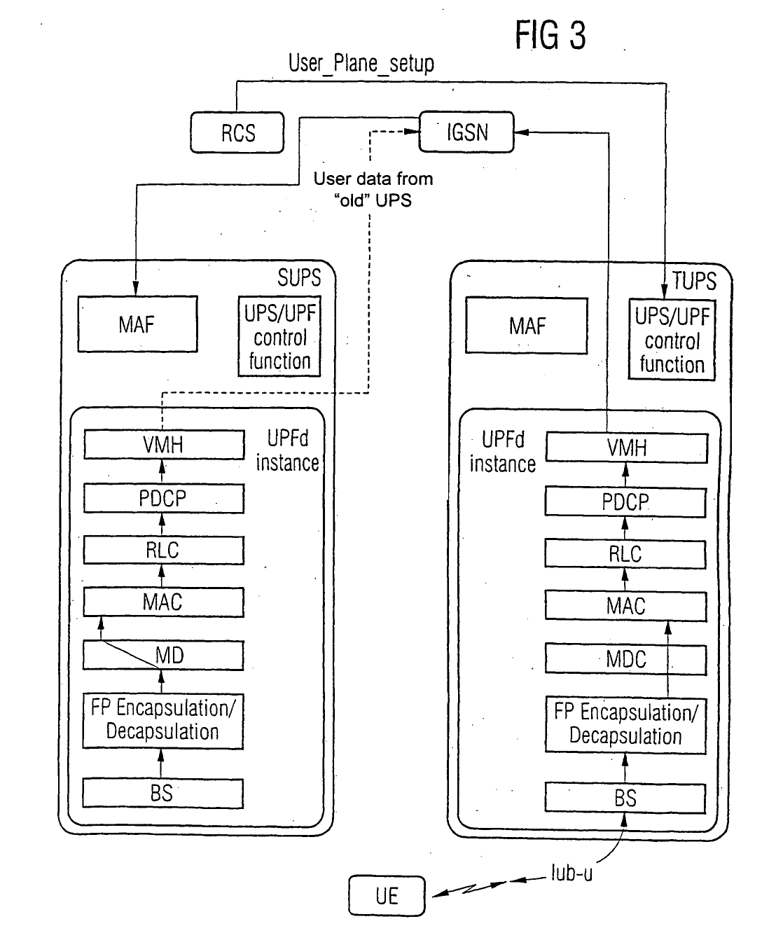

FIGS. 3-5 schematic diagrams of the system situations in a communication network during relocation of the diversity point of a mobile station with a hard handover.

As shown in FIGS. 1 and 2, the communication network according to FIG. 2 is essentially set up in the same way as the communication network shown in FIG. 1.

To distinguish the new technology, the radio network controllers SRNC and DRNC are referred to below as serving user plane servers S-UPS or target user plane servers T-UPS.

The core network CN also has an integrated GPRS service node (GPRS: General Packet Radio Service). This serves as a gateway or interface between the core network CN and the radio access network RAN. The radio access network RAN has a number of devices of relevance here, in particular the user plane server UPS, via which connections are set up and maintained with stationary or mobile user stations UE. The base stations assigned to the user plane servers UPS are also components of the RAN but are not shown here.

Further devices in the radio access network RAN are what are known as routers R, which serve as interfaces with what is known as the IP backbone, in other words internet-protocol-controlled trunk lines or main lines.

The radio access network RAN also comprises user equipment functions UEF for all the signaling of a mobile station UE. There is also a home agent in the radio access network and this is used to register mobile users or mobile stations UE in the same way as the home register in existing radio communication networks.

User plane functions UPF are usually present in serving user plane servers S-UPS and these are responsible for transmitting useful data from one node (S-UPS) to a terminal.

With the exemplary embodiment shown here, a relocation method is proposed, in which a combination of radio-specific protocols, as known for example [from] UMTS-specific protocols, and IP-based protocols, as known for example from the IETF-standardized mobility protocol “Mobile IP Version 6 (MIPv6)”, is used.

To signal the handover of management of the mobile station UE and/or the transmission of data to be transmitted to the mobile station UE from the S-UPS to the T-UPS, an MIP protocol in particular is used in conjunction with a protocol from a mobile radio system.

The signaling protocols for a mobile station UE are, as already mentioned, operated in the radio access network RAN by what is known as the user equipment function UEF.

A virtual mobile host VMH is provided for relocating a mobile station using an MIP protocol and this serves as the client for MIP registration.

The user plane server UPS also comprises a mobile anchor function MAF, via which messages are routed from and to a mobile station UE.

The course of a relocation process is described briefly below using FIG. 2.

When a mobile station UE registers in the radio access network RAN by communication contact via a base station BS, IP registration for this mobile station UE takes place with the home agent HA, the local mobile anchor function MAF and the core network CN, so that data packets routed downstream towards the mobile station are routed via the S-UPS.

If the mobile station UE has a diversity leg, by means of which it is connected to a base station BS, which is linked to the serving user plane server S-UPS, IP re-registration does not take place for the mobile station UE.

UMTS-specific mobility functions are responsible for the addition or removal or diversity legs during a soft handover.

The removal of diversity legs is generally initiated by cell update messages from the mobile station UE.

If, after the removal of a diversity leg, the user equipment function UEF detects that the last diversity leg between the mobile station UE and the serving user plane server S-UPS has been removed, the UEF generates a user plane function UPF in the target user plane server T-UPS, as shown in FIG. 2 by the arrow marked 1.

Similarly the user equipment function UEF generates a user plane function UPF in the target user plane server T-UPS, when the UEF receives a request for a hard handover.

The user equipment function UEF also sends the target user plane server UPS a message to set up a virtual mobile host VMH (this may also be a component of the newly set up UPF). MIP registration can start using the newly set up virtual host VMH.

The transmission path between the core network CN and the mobile station UE is changed on the IP layer by an MIP registration process (“binding update”), which is initiated by the new serving user plane server S-UPS. The virtual mobile host VMH then registers using MIP with the local MAF, as shown by the arrow 2, with the home agent HA, as shown by the arrow 3 and with the core network CN, as shown by the arrow 7. MIP registration can optionally also be carried out by an MIP client function, which is provided in the mobile station UE.

The MIP client function (the virtual mobile host VMH) also sends a connection update to the mobile anchor function (MAF) of the former serving user plane server S-UPS, with the result that the data transmitted downstream is re-routed to the target user plane server T-UPS, as shown by the arrow 4. The connection update in particular contains the address of the mobile anchor function MAF of the target user plane server T-UPS.

This means that data packets which are still on the way to the old serving user plane server S-UPS or are temporarily stored, can still reach the mobile station via the connection between the two mobile anchor functions MAF (arrow 6), as this connection is maintained for a certain period. Deletion of the last diversity leg or the last connection does not take place until after the end of a changeover period after the handover of management.

Finally the user equipment function UEF instructs the old serving user plane server S-UPS to delete the resources for the mobile station UE (arrow 5).

With regard to the UMTS selected as an example of a basic communication system, for the principles and registration functions, see also in particular MIPv6, in particular the IETF spec publications “Mobility support in Ipv6”, draft-ietf-mobile IP-Ipv6-12. The integration of MIPv6 offers a number of advantages:

It allows a device to send data packets to a mobile station UE with a fixed IP address, with said fixed IP address being independent of the actual current point of connection of this mobile station UE to the IP network, in our case the connection to the base station BS of the radio access network RAN. This means in particular that the user plane protocol layers above the internet protocol IP do not have to make changes to IP addresses.

MIPv6 software is also available as commercial IP software, thus saving on development work.

The solution described above can in particular be used in a distributed IP-based RAN architecture, in which functions on the user plan and functions on the control plane are distributed across a number of physical nodes.

To deploy the relocation method according to the invention, it is proposed on the one hand that some of the IP standard mechanisms be changed, in order to accelerate the relocation procedure, and on the other hand that the UMTS functionality be modified, in order to prevent packet losses during the relocation procedure.

The relocation process for setting up a new serving user plane server UPS with a hard handover is described below using FIGS. 3-5.

FIG. 3 shows the situation in which a first user plane server S-UPS is the serving user plane server and a second user plane server TUPS is the target user plane server. The user equipment functions UEF are located in the radio control server RCS, which represents a physical node. The existing radio access network RAN has a distributed architecture. The user plane functions, which relate to a single mobile station UE, are shown as dedicated user plane functions UPFd. These dedicated user plane functions UPFd are each managed in a user plane server UPS. The functional blocks VMH, PDCP, RLC, MAC, MDF and FP are subfunctions of the entity UPFd.

The dedicated user plane functions UPFd are generated by corresponding control plane messages, as described above.

In the core network CN the integrated GPRS service node serves as a gateway to the radio access network RAN. The integrated GPRS service node converts user data transmitted downstream into IP data packets, which have the address of the virtual mobile host VMH as the destination address and the address of the integrated GPRS service node as the source address.

The virtual mobile host has a local IP address, which is generally referred to as the “care-of address” and registers with this with the home agent HA, the mobile anchor function MAF and the integrated GPRS service node, with the result that data which is transmitted in a downstream direction and arrives at the IGSN node is forwarded to the local mobile anchor function MAF and to the virtual mobile host. The VMH decapsulates the IP data packets and transmits the user data to the base station. The virtual mobile host VMH processes the user data received via the radio connection (via the node B) in an upstream direction and sends it directly to the IGSN service node.

The relocation of the serving user plane server is described below based on this system situation.

After activation of the mobile station UE, the radio control server RCS initiates the relocation procedure by generating a virtual mobile host VMH at the target user plane server T-UPS via a User_Plane_Setup instruction, as shown in FIG. 3. This instruction generates terminal-specific instances in a user plane function UPFd, in particular the instances PDCP, RLC, MAC and VMH in the target user plane server T-UPS.

The radio control server also instructs the base station BS to set up a radio connection. In this situation data transmitted upstream from the mobile station UE can reach the IGSN service node via the radio connection, the base station BS and the target user plane server T-UPS.

Data transmitted downstream, which still arrives at the former serving user plane server S-UPS can no longer be forwarded via the radio connection and has to be stored temporarily in the mobile function MAF of the S-UPS.

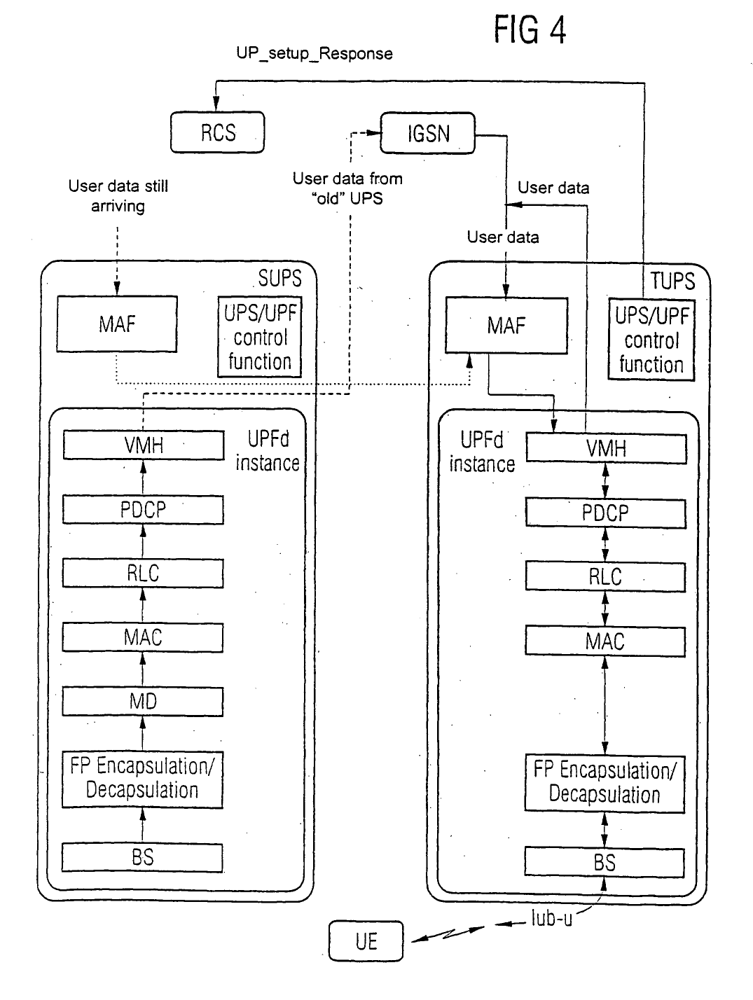

In order to be able to forward data to the mobile station, the new virtual mobile host automatically sends connection updates (address messages) to the MAF of the T-UPS, to the HA and to the IGSN service node. The virtual mobile host VMH also sends a connection update to the MAF of the S-UPS, as a result of which the address of the mobile anchor function MAF of the T-UPS is registered as the new care-of address. In this situation (FIG. 4) the data packets still on their way to the S-UPS or temporarily stored are transmitted from the MAF of the S-UPS to the MAF of the T-UPS, as a result of which they are forwarded to the dedicated user plane function UPFd in the T-UPS and to the mobile station UE.

Data packets which arrive at the IGSN service node or at the home agent HA (not shown) are now routed directly to the MAF of the T-UPS and from there on to the mobile station UE.

The target user plane server T-UPS informs the radio control server RCS that the handover is completed (insofar as it affects the T-UPS). A UP_setup_Antwort response is transmitted for this purpose.

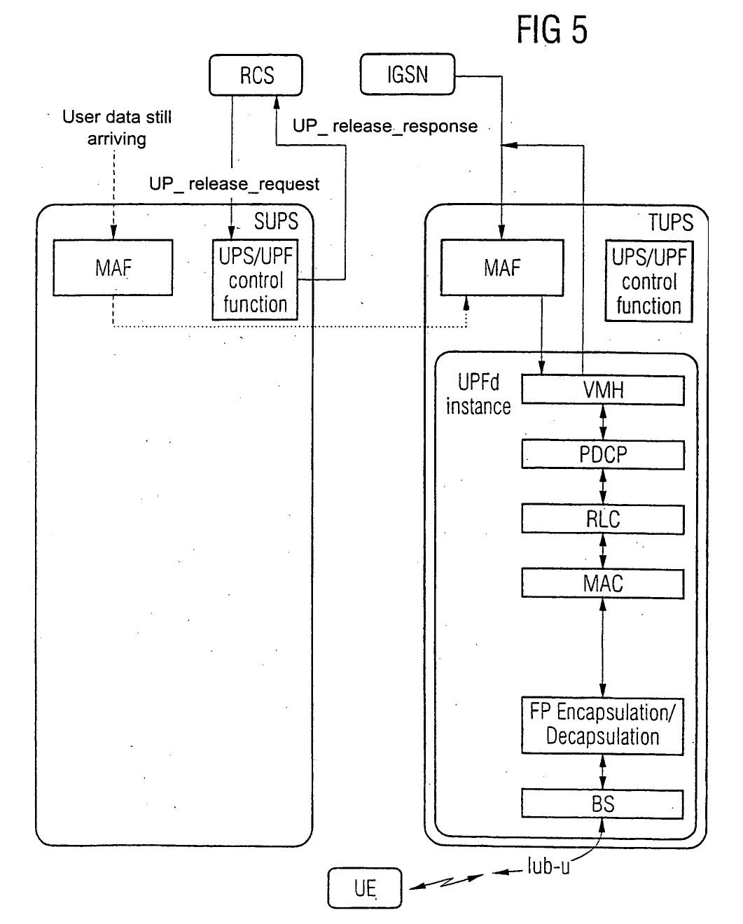

As shown in FIG. 5, the radio control server RCS deletes the dedicated user plane function UPFd in the serving user plane server UPS after receipt of the UP_setup_Antwort response and sends a UP_freigeben (release) notification to the S-UPS.

After the S-UPS has received the UP_freigeben request, it waits until corresponding buffers are empty, before the former serving user plane server S-UPS deletes the dedicated user plane function UPFd including the virtual mobile host VMH and responds to the UP_freigeben request with a UP_freigeben_antwort message.

References

| | |
|---|---|
| UE | Mobile station |
| MDF | Macrodiversity function |
| SRNC | Serving radio network controller |
| DRNC | Drift radio network controller |
| CN | Core network |
| R | Router |
| HA | Home agent |
| UEF | User equipment function |
| RCS | Radio control server |
| IGSN | Integrated GPRS service node |
| RAN | Radio access network |
| VMH | Virtual mobile host |
| BS | Base station |
| S-UPS | Serving user plane server |
| T-UPS | Target user plane server |
| UPFd | Dedicated user plane function |
| MAF | Mobile anchor function |
| MAC | Medium access control plane |

1. Method for relocating a mobile station (UE) in a communication network, comprising a core network (CN) and a radio communication network (RAN) with at least one first and one second radio network controller (UPS), with the option of handing over management of the mobile station (UE) and/or the transmission of data to be transmitted to the mobile station (UE) from the first radio network controller (S-UPS) to the second radio network controller (T-UPS)
characterized in that
data which arrives at the first radio network controller (S-UPS) after a handover or is stored there temporarily, is transmitted using a functionality of the first radio network controller (S-UPS) to a corresponding functionality of the second radio network controller (T-UPS) and forwarded from there to the mobile station (UE).

2. Method according to claim 1,
characterized in that
the functionality of the first and second radio network controllers (S-UPS, T-UPS) is a mobile anchor function (MAF).

3. Method according to claim 1 or 2,
characterized in that
the transmission route between the core network (CN) and the mobile station (UE) is changed in the event of a handover using a mobile internet protocol (MIP) (MIP registration).

4. Method according to claim 3,
characterized in that
a virtual mobile host (VMH) is generated as the client for carrying out the MIP registration.

5. Method according to claim 4,
characterized in that
the mobile host is generated in the second radio network controller (T-UPS).

6. Method according to claim 4 or 5,
characterized in that
an MIP client in the mobile station (UE) or the virtual mobile host (VMH) in the serving radio network controller (UPS) registers with the local mobile anchor function (MAF), a home agent (HA) and in the core network (CN).

7. Method according to claims 4 to 6,
characterized in that
the generation of the virtual mobile host (VMH) is initiated by a radio control server (RCS), in particular by a user equipment function (UEF) provided in the radio control server (RCS).

8. Method according to one of claims 4 to 7,
characterized in that
the MIP client or the virtual mobile host (VMH) transmits the address of the mobile anchor function (MAF) of the second radio network controller (T-UPS) to the mobile anchor function (MAF) of the first radio network controller (S-UPS).

9. Method according to one of the preceding claims,
characterized in that
the handover is initiated by the mobile station (UE).

10. Method according to one of the preceding claims,
characterized in that
during the handover of management or the transmission of data between the radio network controllers (S-UPS, T-UPS), data arriving at the second radio network controller (T-UPS) is stored temporarily.

11. Method according to one of the preceding claims,
characterized in that
after a user plane function (UPF) has been set up in the second radio network controller (T-UPS), the resources for the mobile station (UE), in particular the user plane function (UPF), are deleted in the first radio network controller.

12. Method according to one of the preceding claims,
characterized in that
MIP-V6 is used to signal the handover of management of the mobile station (UE) and/or the transmission of data to be transmitted to the mobile station (UE).

13. Radio communication system with at least one first and one second radio network controller (UPS) to manage at least one mobile station (UE), with the option of handing over the management of the mobile station (UE) and/or the transmission of data to be transmitted to the mobile station from the first radio network controller (S-UPS) to the second radio network controller (T-UPS),
characterized in that
a device is provided to implement the method according to one of the preceding claims, in particular a virtual mobile host.
